(19) United States
(12) Patent Application Publication
(10) Pub. No.: US 2013/0278132 A1
(43) Pub. Date: Oct. 24, 2013

(54) LED BULBS WITH ADJUSTABLE LIGHT EMITTING DIRECTION

(71) Applicants: Zengguang Yuan, Middleburg Heights, OH (US); Ching Fong, Ann Arbor, MI (US)

(72) Inventors: Zengguang Yuan, Middleburg Heights, OH (US); Ching Fong, Ann Arbor, MI (US)

(21) Appl. No.: 13/878,395

(22) PCT Filed: Oct. 11, 2011
(86) PCT No.: PCT/US2011/055848

§ 371 Date: Jul. 10, 2013

Related U.S. Application Data
(60) Provisional application No. 61/404,869, filed on Oct. 12, 2010.

(51) Int. Cl. F21K 99/00

(52) U.S. Cl. CPC F21K 9/1355
USPC 313/46; 313/312

(57) ABSTRACT

The invention provides modular, interchangeable LED light bulbs configured to have an adjustable lateral emission direction. Such light bulbs overcome the drawbacks of conventional LED light bulbs that are not suited for use certain application, such as with sideway mounted light fixtures.

### PRIORITY CLAIMS AND RELATED APPLICATIONS

This application claims the benefit of priority from PCT/US11/55848, filed Oct. 11, 2011, which claims the benefit of priority from U.S. Provisional Application Ser. No. 61/404,869, filed Oct. 12, 2010, the entire content of each of which is incorporated herein by reference for all purposes.

### TECHNICAL FIELDS OF THE INVENTION

The invention generally relates to LED-based light devices. More particularly, the invention relates to interchangeable, modular LED light bulbs that are configured to have an adjustable lateral emission direction.

### BACKGROUND OF THE INVENTION

Light-emitting diode (LED) is a semiconductor light source. The light output of individual LEDs is small compared to typical incandescent and compact fluorescent lamps. As a result, LED lamps often use light bulbs that have multiple diodes. In recent years, high power LEDs with higher light output have been developed. LED lamps have become available as replacements for both general and special-purpose lightings, including screw-in incandescent or compact fluorescent light bulbs. LEDs naturally emit many colors; therefore, removing the need for color filters, which can greatly improve the energy efficiency over a white light source.

Although incandescent light bulbs are inexpensive to manufacture, they are energy inefficient. They have short lifespan and need frequent replacement and routine maintenance. Compact fluorescent bulbs are more efficient but contain mercury and are also slow to reach its full brightness. Compared to fluorescent light bulbs, LED light bulbs are more environmentally friendly as they contain no mercury. LED bulbs turn on instantly, and their lifetime is not affected by repeated on-off cycles, making them well suited for lighting fixtures where bulbs are frequently turned on and off. Last but not least, LED light bulbs are mechanically robust and are subject to little wear and tear if operated properly. Compared to conventional light bulbs, LED lamps have much longer service life and require little routine maintenance.

A common feature of LED light bulbs is that they emit light in the forward hemisphere, unlike incandescent bulbs that emit light in all directions. Furthermore, the light intensity from an LED bulb varies with angular direction based on the intensity profile of the light generating chips in a bulb. Light is brightest in its longitudinal direction. Because of the intensity profile and construction of a typical LED bulb on the market today, they are suited for downward lighting fixtures (lighting emitting hemisphere facing the ground). However, in a typical household and office environment, many light fixtures require light bulbs to be mounted sideways, in which situation a typical LED bulb would have its most intense light projection parallel to the ceiling, away from the intended direction (typically the space below the light fixture). Therefore, when used in these situations conventional LED light bulbs are ineffective and/or inefficient.

Therefore, a need exists for LED light bulbs that address afore-mentioned shortcomings.

### SUMMARY OF THE INVENTION

The present invention addresses the shortcomings of conventional LED light bulbs and provides modular, interchangeable LED light bulbs that are designed to have a directionally adjustable lateral emission profile. Such light bulbs overcome the drawbacks of conventional LED light bulbs that are not suited for use certain application, such as with sideway mounted light fixtures.

In one aspect, the invention generally relates to an LED light bulb that includes a rotational bulb base. The bulb base has a rotational axis that allows secure locking of the bulb base to a matching bulb power socket through a rotational movement. The light bulb has a hemispherical emission profile with its most intense emission perpendicular to the rotational axis. The hemispherical emission profile is directionally adjustable nearly 360° by a rotational movement around the rotational axis without simultaneously unlocking the bulb base from the bulb power socket.

In another aspect, the invention generally relates to an LED light bulb, which includes: (a) a rotational bulb base portion having a rotational axis allowing secure-locking of the base portion to a matching bulb power socket through a rotational movement, and (b) a light-emitting front portion connected to the inner cylinder of the base portion. The base portion includes: an exposed positive electrical connection site and an exposed negative electrical connection site for electrical communication with the power socket; an inner cylinder having a first groove circularly placed around its outer surface and a first outward protruding lug; a matching outer cylinder having a spatially matching second groove on its inner surface and a second matching inward protruding lug; and a C-shaped circular spring ring having such a cross-sectional profile—that, when the inner half of the spring ring fits in the first groove around the outer surface of the inner cylinder, the outer half of the same spring ring fits in the matching second groove around the inner surface of the outer cylinder. The axial distances between the grooves to the corresponding lugs are the same so that after the C-shaped spring engages the two grooves, the two lugs, the inner one and the outer one, are in the same plane perpendicular to the axis of the rotational base. When a user installs the bulb to its matching socket by rotating it, eventually, the first outward protruding lug will intercepts the second outward protruding lug when the inner cylinder is rotated relative to the outer cylinder. Once the rotational base is engaged with the matching socket, the user can turn the bulb backwards until the emitted light is in the desired direction. The light-emitting front portion includes: a circuit board electrically coupled to the positive electrical connection site and the negative electrical connection site; an LED assembly comprising one or more LEDs and electrically coupled to the circuit board such that the one or more LEDs collectively provide a hemispherical emission profile directed laterally to the rotational axis of the base portion; and a heat sink thermally coupled to the LED assembly and being capable of facilitating heat dispersion to ambient environment. The light-emitting front portion and the rotational bulb base portion collectively define a light bulb-like structure.

In yet another aspect, the invention generally relates to an LED light bulb that includes: (a) a rotational bulb base portion that has a rotational axis allowing secure locking of the base portion to a matching bulb power socket through a rotational movement, and (b) a light-emitting front portion connected to the inner cylinder of the base portion. The base portion includes: an exposed positive electrical connection site and an exposed negative electrical connection site for electrical communication with the socket; an inner cylinder having a groove circularly placed around its outer surface, the groove having a stop block;

an outer cylinder matching the inner cylinder, the outer cylinder comprising an opening aligned with the groove of the inner cylinder; an intercepting pin protruding through the opening of the outer cylinder; and an outer shell matching the outer surface of the outer cylinder; wherein the intercepting pin intercepts the stop block of the groove when the inner cylinder is rotated relative to the outer cylinder. The light-emitting front portion includes: a circuit board electrically coupled to the positive electrical connection site and the negative electrical connection site; an LED assembly comprising one or more LEDs electrically coupled to the circuit board such that the one or more LEDs collectively provide a hemispherical emission profile directed laterally to the rotational axis of the base portion; and a heat sink thermally coupled to the LED assembly and being capable of facilitating heat dispersion to ambient environment. The light-emitting front portion and the rotational bulb base portion collectively define a light bulb-like structure.

### BRIEF DESCRIPTION OF THE DRAWINGS

FIG. 1A shows an illustrative example of a conventional LED-based light bulb. FIG. 1B shows an illustrative example of an open view of a conventional LED-based light bulb.

FIG. 2 shows illustrative examples of LED-based light bulbs, some of which have light diffusers while some do not.

FIG. 3 shows schematic illustrations of light emitting patterns of a conventional incandescent light bulb and a LED light bulb.

FIG. 4 shows a schematic illustration of directional light intensity distribution from an LED chip.

FIG. 5 shows a schematic illustration of directional light intensity distribution from an LED light bulb.

FIG. 6 shows an example of a downward light fixture.

FIG. 7 shows an example of light fixtures that require light bulbs to be mounted sideways.

FIG. 8 shows a schematic illustration of an LED light bulb that is suitable to a sideway-mounted socket.

FIG. 9 shows a schematic illustration (a dissected view) of an embodiment of the invention, showing relative positions of various parts in the bulb.

FIG. 10 shows a schematic illustration of an embodiment of the invention, wherein the diffuser is facing to the direction normal to the axial direction of the bulb.

FIG. 11 shows a schematic illustration of an embodiment of the interior structure of the outer cylinder of the base portion of a LED light bulb of this invention.

FIG. 12 shows a schematic illustration of an embodiment of inner core of the base portion of an LED bulb according to the invention matching the outer cylinder shown in FIG. 11.

FIG. 13 shows a schematic illustration of a cross-sectional view of the inner core and the outer cylinder, as illustrated in FIG. 12 and FIG. 11, which are in a locked position.

FIG. 14 shows a schematic illustration of an exemplary open view of an LED light bulb of the invention, showing the interaction between the two lugs attached to the inner cylinder and the outer cylinder.

FIG. 15 shows a schematic illustration (a dissected view) of an embodiment of an LED bulb of this invention.

FIG. 16 shows a schematic illustration of an exemplary inner cylinder of the base portion of an LED light bulb of this invention.

FIG. 17 shows a schematic illustration of an exemplary sectional view of the outer cylinder of an LED light bulb of this invention.

FIG. 18 shows a schematic illustration of an exemplary sectional view of the base assembly of an LED light bulb of this invention.

FIGS. 19 A and B show schematic illustrations of printed circuit board.

### DETAILED DESCRIPTION OF THE INVENTION

The invention is based on novel designs that provide modular, interchangeable LED light bulbs that are configured to have an adjustable lateral emission direction. Such light bulbs overcome the drawbacks of conventional LED light bulbs that are not suited for use in certain applications, such as with sideway-mounted light fixtures.

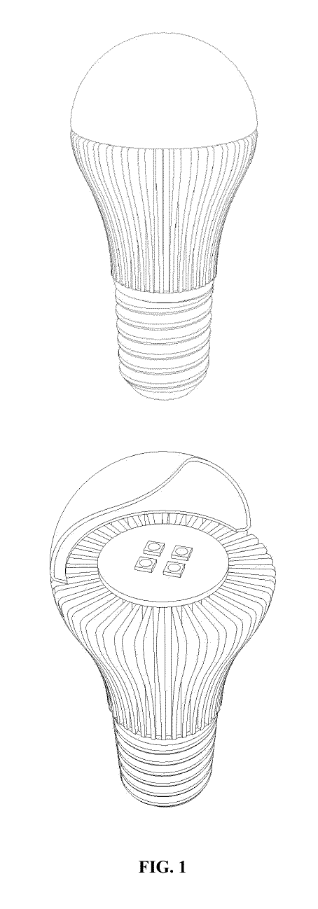

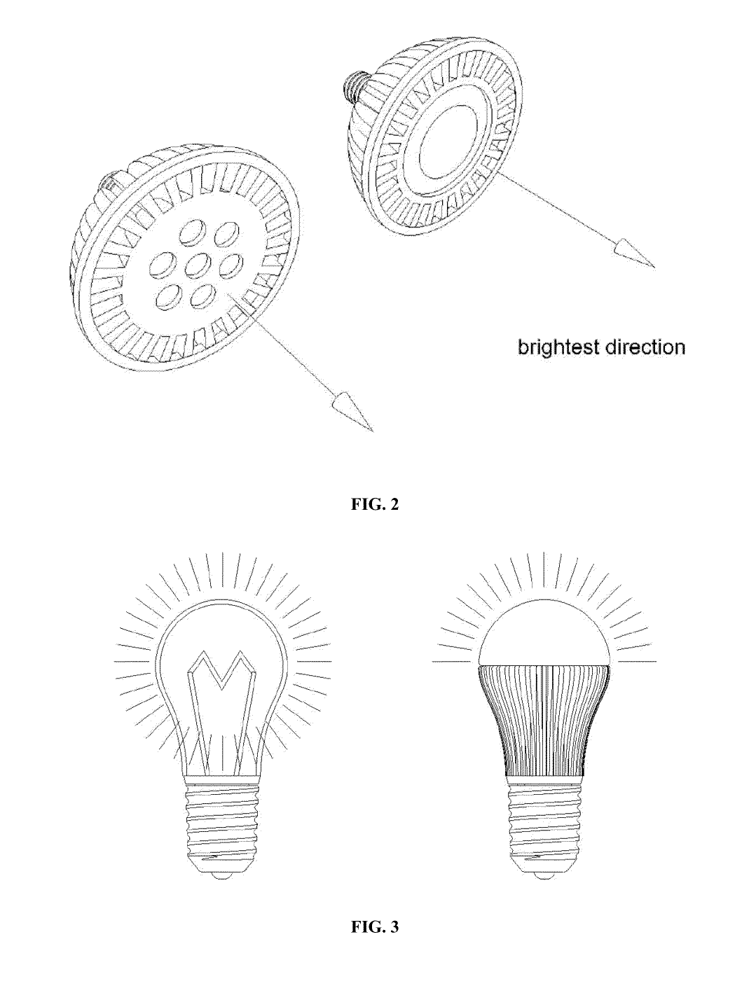

As shown in FIG. 1A and FIG. 1B, a typical LED bulb has a screw base that is the same as what a conventional bulb has. It also has a circuit board populated with one or several LEDs as light generating devices. On the same circuit board, usually on the opposite side to which the LEDs are mounted are the LED driving circuit and related components. Since LED lamps are damaged if operated at high temperatures, they typically are equipped with heat management elements (e.g., heat sinks or cooling fins) for transferring heat from the electrical components to ambience. In front of the LEDs is often found a diffuser shell to make the light soft. Some of them have diffusers and others do not (FIG. 2).

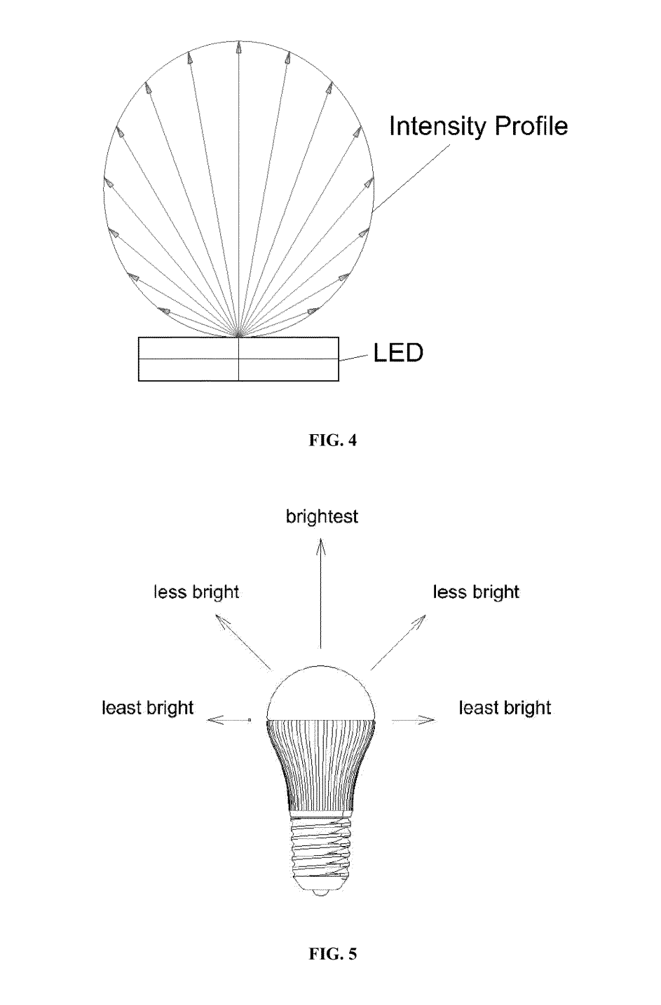

Unlike typical incandescent light bulbs that emit light in all directions, LED bulbs emit light into the forward hemisphere (FIG. 3), and the light intensity varies with angular directions (e.g., FIG. 4 wherein the length of the arrow indicates the light intensity). An LED bulb is brightest in its longitudinal direction (FIG. 5). Therefore, the light appears brightest when viewed straight on.

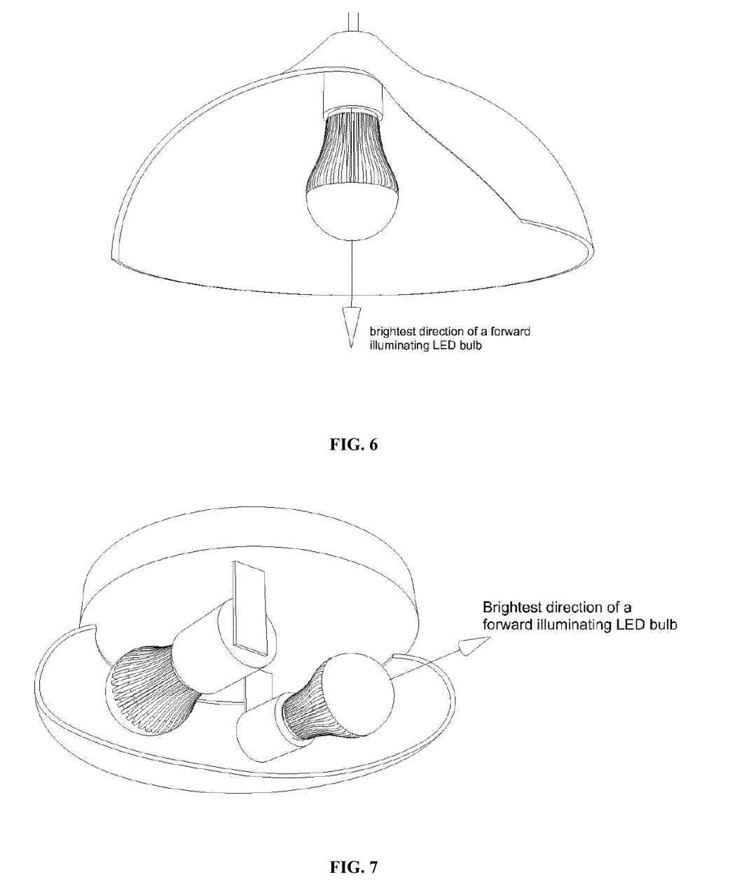

Because of their brightness profile, the LED bulbs on the market to date are best suited for downward light fixtures, such as shown in FIG. 6. In such mounting configurations, the LED light bulb faces the downward direction and emits light in a hemisphere facing the floor, thereby most efficiently lighting up the space below the light fixture. Regular LED bulbs in the market today emit light forward along the axial direction of the bulb. Since the light beam from LED bulbs is highly directional, when screwed in horizontal position such as a wall-mounted socket, these bulbs emit light in a horizontal direction, whereas the desired light direction is vertically downward.

In a typical household or workspace, however, many ceiling- or wall-mounted light fixtures require light bulbs to be mounted sideways (or horizontally, e.g., as shown in FIG. 7). When a typical LED bulb is mounted sideways, its brightness profile is such that the direction with the most intense light is parallel to the ceiling rather than downward perpendicular to the ceiling, the intended area for illumination. In other words, the majority of the light emitted from the LED bulb will travel along the ceiling, rather than lighting up the area below the light fixture. Therefore, when LED light bulbs are used with these sockets, they become awkward and inefficient.

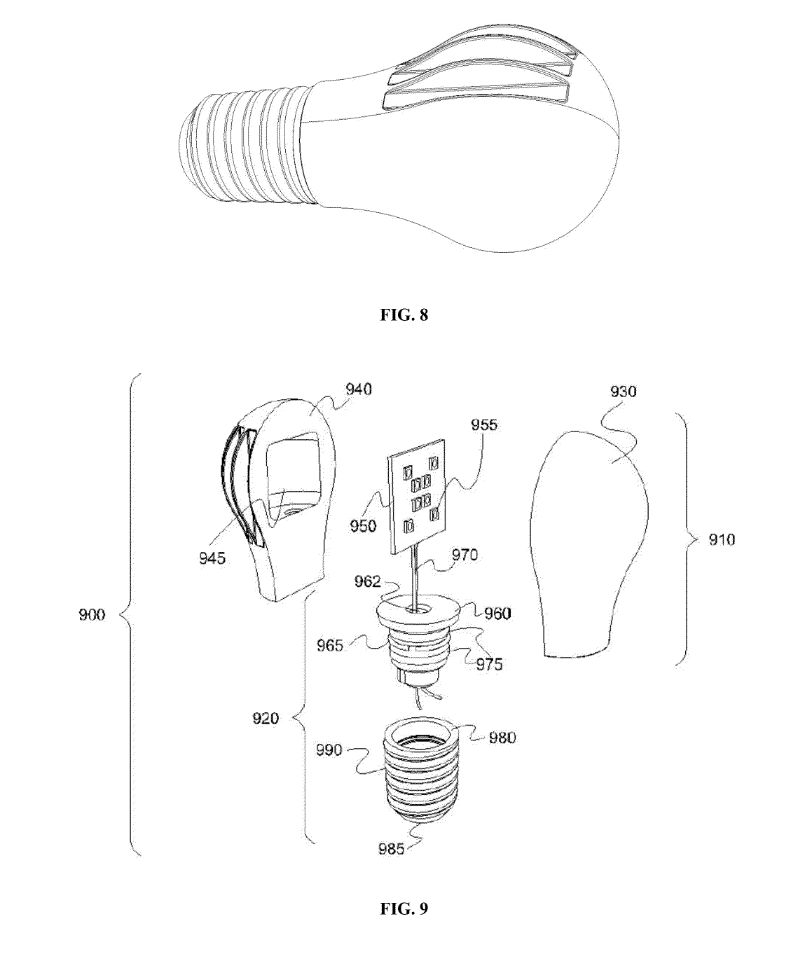

An LED bulb as depicted in FIG. 8 could address the problem, i.e., with the light emitting diffuser facing the ground. However, simply turning the circuit board, the heat sink, and the diffuser sphere 90° degrees in a conventional LED bulb will not be enough to solve the problem because when a user screw the bulb into the socket, one does not know which direction the emitting diffuser will end up faced with. It could very well be facing sideways or even upward.

Thus, LED bulbs used in certain wall- or ceiling-mounted sockets must meet the following two requirements to project light to the intended direction: (a) Light is emitted from the light bulb in a lateral direction, and (b) after screwed in place, the orientation of light-emitting profile of the LED bulb is adjustable to the desired direction (i.e., the light diffuser part of the bulb should be able to rotate vs. the base of the bulb).

The present invention solves the problem by designing the LED bulb such that it meets both requirements. The LED bulbs of the invention allow the user to screw the bulb in/out a socket, as well as to adjust the light-emitting angle while the bulb base is locked in the socket. Thus, the invention enables LED light bulbs to be used with conventional bulb sockets mounted on the ceiling or wall, such as those often found above the sink in a bathroom.

In one exemplary embodiment, as illustrated in FIG. 9, the light bulb 900 includes a light-emitting front portion 910 and a rotational base portion 920. The front portion 910 includes a hemisphere-shaped diffuser 930, a heat sink 940 (e.g., with a cavity 945 to allow space for the LED driving components on the opposite side of the circuit board 950, if any driving components are mounted on the opposite side of circuit board 950), a circuit board 950, one or more LEDs forming an LED assembly 955 populated on the diffuser side of the circuit board 950, LED driving circuit and driving components on the diffuser side and/or on the opposite side (not shown). (There is a tunnel (a passageway) in heat sink for wires to go through.)

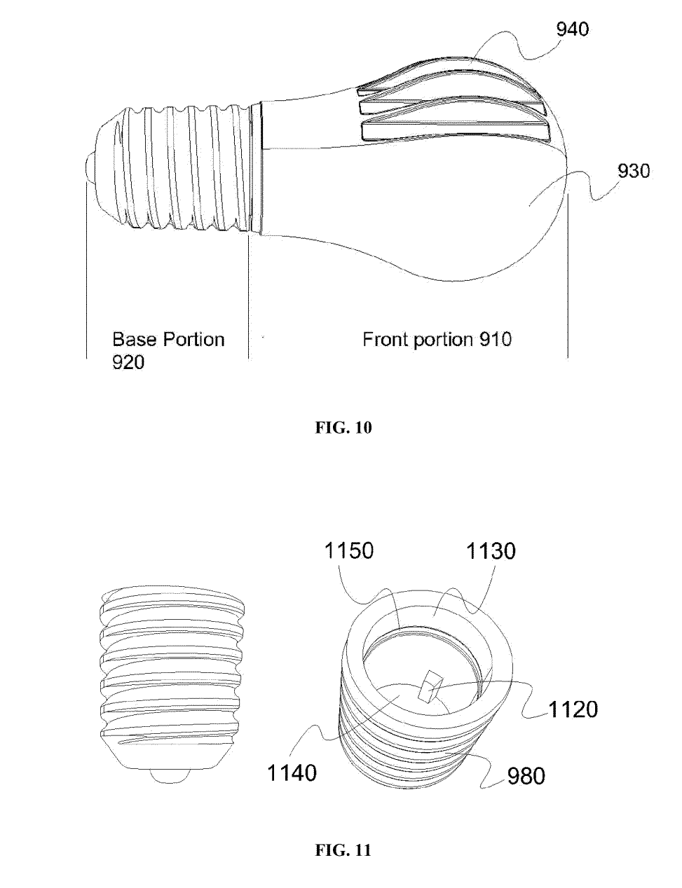

The base portion 920 has two concentric cylinders, an outer cylinder 980 and an inner cylinder 960 a spring ring 965, a pair of wires 970, and one or more frictional bands or materials 975 attached to the outer surface of the inner cylinder 960. The inner cylinder 960 has a hollow passageway 962 for passing through electrical wires 970. The outer cylinder 980 has a first electrical contact terminal 985 and a second electrical contact terminal 990. When fully assembled, the LED bulb 900 looks as shown in FIG. 10. Note that the diffuser faces the direction normal (perpendicular) to the axial direction of the bulb (axis 995).

FIG. 11 shows the interior structure of the outer cylinder 980 of the base portion 920 of the LED bulb 900. The outer surface of the outer cylinder 980 is preferably threaded allowing screw-in of the base portion 920 into an electric power socket (e.g., a conventional electric power socket that fits a regular incandescent light bulb). Inside the outer cylinder 980 and near or at the bottom (distal base portion, as shown in FIG. 11), a lug 1120 (e.g., a trapezoid-shaped as shown, the “outer” lug) intrudes inwardly from the interior wall surface 1130 and/or the interior bottom surface 1140. A groove 1150 circles along the interior wall surface 1130.

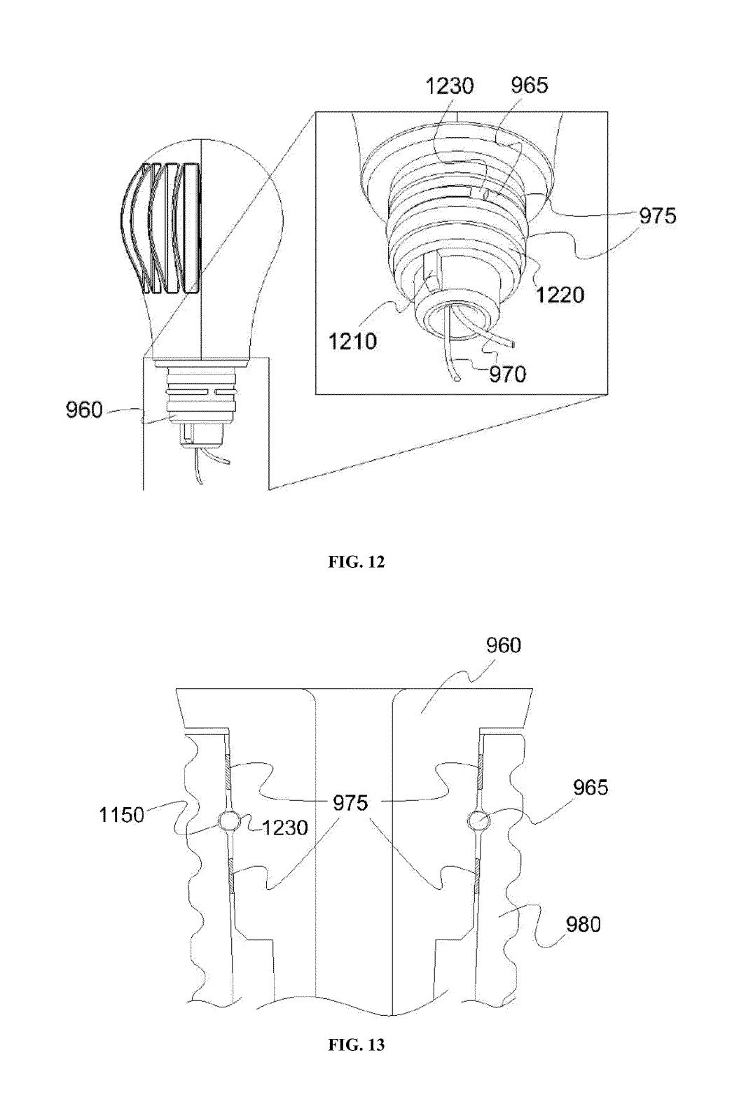

As shown in FIG. 12, the inner cylinder 960 is fixed to the front portion 910 of the bulb 900. A lug 1210 (the “inner” lug) protrudes outwardly from the bottom portion of the outer surface 1220 of the inner cylinder 960. On the outer surface 1220 is fixed one or more frictional bands 975 (two shown). Also on the outer surface 1220 of the inner cylinder 960 is a groove 1230 whereon a spring ring 965 is snapped. As shown, the spring ring 965 is a C-shaped ring made of an elastic material (e.g., spring steel). The inner cylinder 960 dimensionally matches the outer cylinder 980. When the inner cylinder 960 is inserted into the outer cylinder 980, the spring ring 965 snaps into the groove 1150 on the inner surface 1130 of the outer cylinder 980, thereby locking the two cylinders together.

FIG. 13 is a cross-sectional view of the inner cylinder 960 and the outer cylinder 980 when they are in a locked position (showing the spring ring 965, the inner cylinder 960, the outer cylinder 980, the groove 1230 on the inner cylinder 960, and the groove 1150 on the inner surface of the outer cylinder 980). Once assembled, the lug 1120 on the interior of the outer cylinder 980 and the lug 1210 on the exterior on the inner cylinder 960 are in the same axial location.

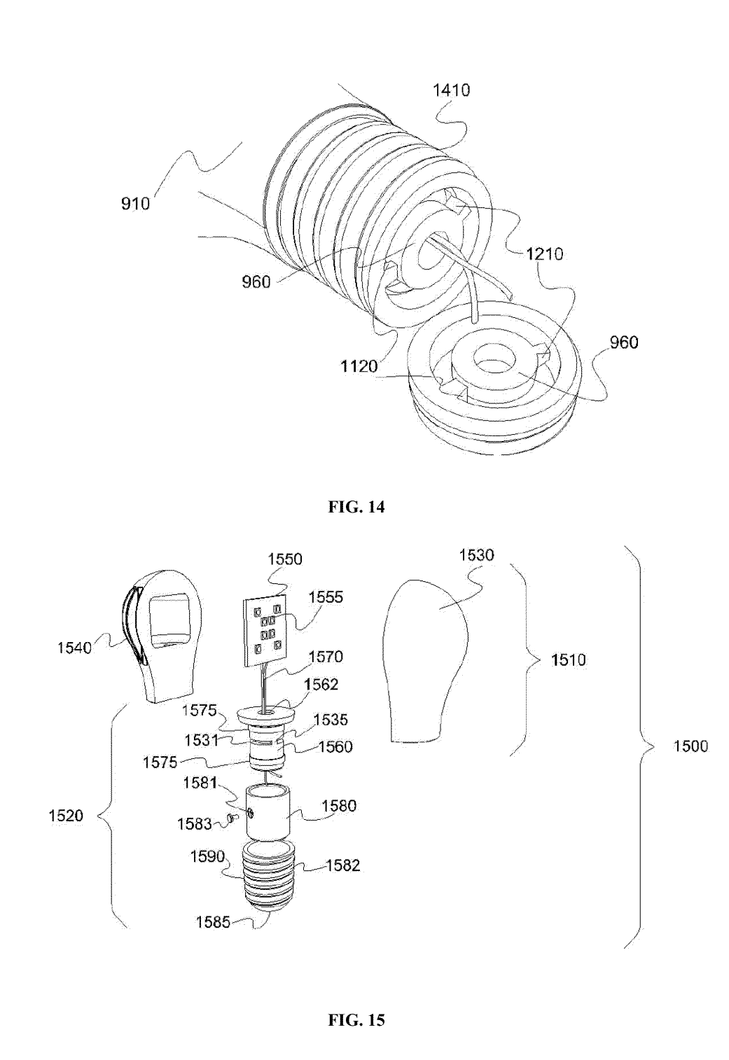

FIG. 14 shows the interaction between the two lugs 1120 and 1210. When a user screws the bulb 900 into a matching electric power socket, he/she holds the front portion of the bulb and turns it clockwise. Since the inner cylinder 960 is fixed to the front portion 910 of the bulb 900, the inner cylinder 960 will also turn clockwise. The outer cylinder 980 with thread 1410 will not turn with the front portion 910 and the inner cylinder 960 until the lug 1210 on the inner cylinder 960 contacts the lug 1120 on the outer cylinder 980. After such contact of the lugs, the outer cylinder 980 with thread 1410 turns with the front portion 910 and the bulb then threads into the socket.

After the bulb 900 is in the socket, one can turn the front portion 910 of the bulb counter-clockwise to ensure the diffuser side (therefore the hemispherical emission profile of the bulb) faces the desired direction. During the turn, the two lugs, 1210 and 1120, depart and disengage from each other. As a result, only the front portion 910 of the bulb will be turned while the outer cylinder 980, which is locked through threads to the electric power socket, will not turn, ensuring that the bulb is still securely engaged in the power socket. Frictional band/material 975 prevents change of the direction of the front portion of the bulb by minor perturbations. Since the inner lug 1210 will not touch the outer lug 1120 on the opposite side until the bulb is turned nearly a full circle counter-clockwise, the bulb can be adjusted to any direction as needed.

When removing the bulb from the socket, one can turn the bulb counter-clockwise until the inner lug 1210 touches the outer lug 1120 on the other side, after which point the two lugs engage again, bring the outer cylinder 980 to rotate counter-clockwise with the front portion 910 of the bulb and remove the whole bulb from the socket. The front portion 910 of the bulb has nearly 360° range of rotation, which is more than enough.

The hollow passageway 962 of the inner cylinder 960 is for the passage of the electric wires 970 to deliver electrical power to the LED assembly 955. Because the relative turning between the inner cylinder 960 (which is fixed to the front portion 910 of the bulb and therefore the LED circuit board 950) and the outer cylinder 980 cannot be more than one full circle, the wires 970 will never be twisted into a knot.

In another exemplary embodiment, as shown in FIG. 15, the light bulb 1500 includes a light-emitting front portion 1510 and a rotational base portion 1520. The front portion 1510 includes a hemisphere-shaped diffuser 1530, a heat sink 1540 (e.g., having a cavity 1545), a circuit board 1550, one or more LEDs forming an LED assembly 1555 populated on the diffuser side of the circuit board 1550, LED driving circuit and driving components on the opposite side (not shown). The base portion 1520 includes three concentric cylinders: an inner cylinder 1560, an outer cylinder 1580, and an outer shell 1582 with threads. The base portion 1520 also includes one or more friction bands or materials 1575 attached to the inner cylinder 1560. The inner cylinder 1560 has a hollow passageway 1562 for passing through electrical wires 1570. The outer cylinder 1580 has an opening 1581 (an orifice) for receiving a lock pin (“intercepting” pin) 1583. The outer shell 1582 has a first electrical contact terminal 1585 and a second electrical contact 1590.

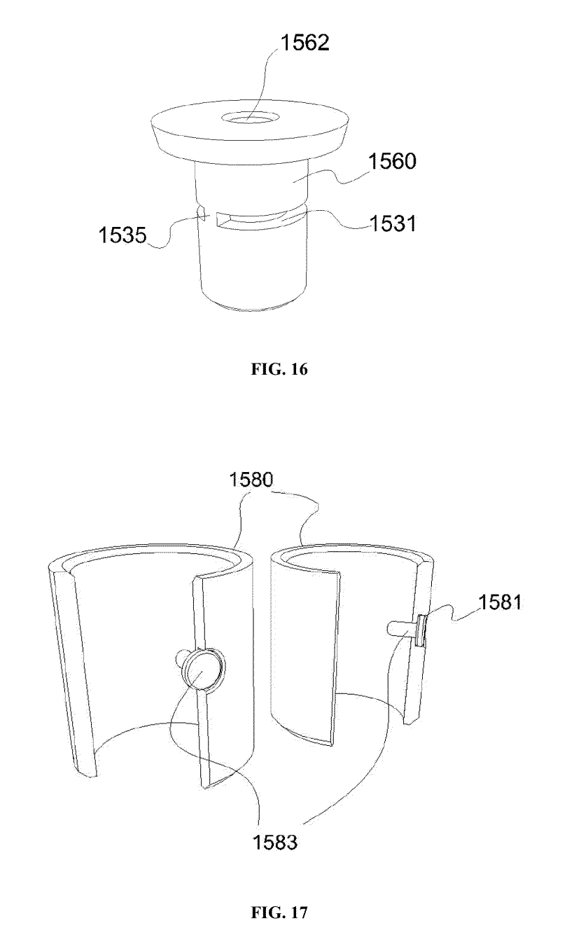

On the outer surface of the inner cylinder 1560 is a groove 1531, wherein a block 1535 is built in place (FIG. 16). FIG. 17 shows a sectional view of the outer cylinder 1580. On the wall of the outer cylinder 1580 is an opening 1581 (an orifice) that receives and secures in place a lock pin 1583. The opening 1581 has an counter bore such that when locked into place the wide end (head) of the pin 1583 does not protrude beyond the outer surface of the outer cylinder 1580.

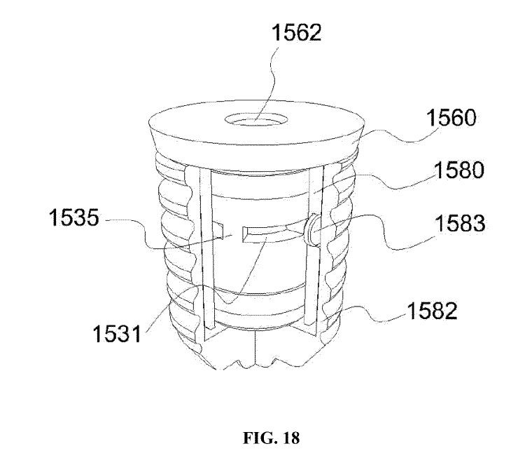

During assembly, the inner cylinder 1560 is first inserted into the outer cylinder 1580, after which the lock pin 1583 is inserted into the opening 1581 (FIG. 17). After the lock pin 1583 is secured (e.g., by an adhesive material), the assembly of inner cylinder 1560 and outer cylinder 1580 is then inserted into and fixed to the outer shell 1582. The outer shell 1582 has threads for screwing into a bulb socket. FIG. 18 shows a sectional view of the base assembly.

When screwing the bulb 1500 into a socket, the user rotates the front portion 1510 clockwise. The inner cylinder 1560, which is fixed to the front portion 1510, will also rotate clockwise. The lock pin 1583, which goes through the side of the outer cylinder 1580, moves along the groove 1531 on the outer surface of the inner cylinder 1560 until it meets the block 1535 along the groove 1531, at which point the lock pin 1583 engages the block, bringing the outer cylinder 1580 to rotate with the inner cylinder 1560 and the front portion 1510 of the bulb. Since the outer cylinder 1580 is fixed to the outer shell 1582 with the thread, the outer shell 1582 will then rotate with the front portion 1510 of the bulb, allowing the bulb 1500 to be screwed into the electric power socket.

After the bulb is screwed in, one can then rotate the front portion 1510 counter-clockwise and leave the light-emitting portion of the bulb (the diffuser side) at the desired direction. During this process, the lock pin 1583 is disengaged from the block 1535 in the groove 1531, therefore the outer cylinder 1580 and the outer shell 1582 will not rotate with the inner cylinder 1560. When the bulb 1500 is to be removed from the socket, the front portion 1510, which is fixed to the inner cylinder 1560 rotates counter-clockwise until the block 1535 in the groove 1531 engages the lock pin 1583 again, at which point the outer cylinder 1580, which is fixed to the outer shell 1582 having thread, will rotate with the inner cylinder 1560 and the front portion 1510 of the bulb, causing the bulb 1500 to be unscrewed from the socket.

The groove 1531 and lock pin 1583 also serve the purpose of preventing the inner cylinder 1560 from sliding outside of the outer cylinder 1580 after the bulb is assembled. A frictional band or material may be applied to prevent change of the direction of the front portion 1510 by minor perturbations. The hollow passageway 1562 in the inner cylinder 1560 is for the passage of the electric wires to deliver electrical power to the LED assembly. Because the relative turning between the inner cylinder 1560 (which is fixed to the front portion 1510 and therefore the LED assembly) and the outer cylinder 1580 cannot be more than one full circle, the wires will never be twisted into a knot.

Thus, in one aspect, the invention generally relates to an LED light bulb that includes a rotational bulb base, which has a rotational axis that allows secure locking of the bulb base to a matching bulb power socket through a rotational movement. The light bulb has a hemispherical emission profile with its most intense emission lateral to the rotational axis. The hemispherical emission profile is directionally adjustable nearly 360° by a rotational movement along the rotational axis without simultaneously unlocking the bulb base from the bulb power socket.

In another aspect, the invention generally relates to an LED light bulb. This light bulb includes: (a) a rotational bulb base portion having a rotational axis allowing secure locking of the base portion to a matching bulb power socket through a rotational movement, and (b) a light-emitting front portion connected to the inner cylinder of the base portion. The base portion includes: an exposed positive electrical connection site and an exposed negative electrical connection site for electrical communication with the power socket; an inner cylinder having a first groove circularly placed around its outer surface and a first outward protruding lug; a matching outer cylinder having a spatially matching second groove on its inner surface and a second matching inward protruding lug; and a C-shaped circular spring ring having a cross-sectional profile such that, when the spring ring is placed in the first groove around the outer surface of the inner cylinder, the spring ring fits in the matching second groove around the inner surface of the outer cylinder. The first outward protruding lug intercepts the second outward protruding lug when the inner cylinder is rotated relative to the outer cylinder. The light-emitting front portion includes: a circuit board electrically coupled to the positive electrical connection site and the negative electrical connection site; an LED assembly comprising one or more LEDs and electrically coupled to the circuit board such that the one or more LEDs collectively provide a hemispherical emission profile directed laterally to the rotational axis of the base portion; and a heat sink thermally coupled to the LED assembly and being capable of facilitating heat dispersion to ambient environment. The light-emitting front portion and the rotational bulb base portion collectively define a light bulb-like structure.

In yet another aspect, the invention generally relates to an LED light bulb that includes: (a) a rotational bulb base portion that has a rotational axis allowing secure locking of the base portion to a matching bulb power socket through a rotational movement, and (b) a light-emitting front portion connected to the inner cylinder of the base portion. The base portion includes: an exposed positive electrical connection site and an exposed negative electrical connection site for electrical communication with the socket; an inner cylinder having a groove circularly placed around its outer surface, the groove having a stop block;

an outer cylinder matching the inner cylinder, the outer cylinder comprising an opening aligned with the groove of the inner cylinder; an intercepting pin protruding through the opening of the outer cylinder; and an outer shell matching the outer surface of the outer cylinder; wherein the intercepting pin intercepts the stop block of the groove when the inner cylinder is rotated relative to the outer cylinder. The light-emitting front portion includes: a circuit board electrically coupled to the positive electrical connection site and the negative electrical connection site; an LED assembly comprising one or more LEDs electrically coupled to the circuit board such that the one or more LEDs collectively provide a hemispherical emission profile directed laterally to the rotational axis of the base portion; and a heat sink thermally coupled to the LED assembly and being capable of facilitating heat dispersion to ambient environment. The light-emitting front portion and the rotational bulb base portion collectively define a light bulb-like structure.

In certain preferred embodiments, the front portion further includes a light diffuser for diffusing light emitted from the one or more LEDs to the ambient.

In certain preferred embodiments, the hemispherical emission profile has its most intense emission directed perpendicular to the rotational axis.

In certain preferred embodiments, the bulb power socket is a standard incandescent bulb socket (e.g., US E26 or Europe E27).

In certain preferred embodiments, the LED assembly comprises from about 1 to about 100 LEDs (e.g., about 2, 5, 10, 20, 30, 40, 50, 60, 70, 80, 90, or 100).

In certain preferred embodiments, the LED light bulb has a luminous efficacy of at least about 30 lumens per electric watt input (e.g., at least about 40, 50, 60, 70, 80, 90, or 100 lumens per electric watt input).

In certain embodiments, the heat sink is made of a material selected from the group consisting of the combination of high thermal conductivity and low cost, such as aluminum.

In certain embodiments, the circular spring ring is made of a material selected from spring steel or certain engineering plastics that have required property of elasticity.

In certain embodiments, the circular spring ring has a diameter from about 0.5 mm to about 5.0 mm (e.g., about 0.5 mm, 1.0 mm, 1.5 mm, 2.0 mm, 2.5 mm, 3.0 mm, 3.5 mm, 4.0 mm, 4.5 mm, or 5.0 mm).

In certain embodiments, the base portion further comprises a circular frictional band of uniform thickness attached to the outer surface of the inner cylinder.

In certain preferred embodiments, the LED light bulb is interchangeable with a standard incandescent light bulb.

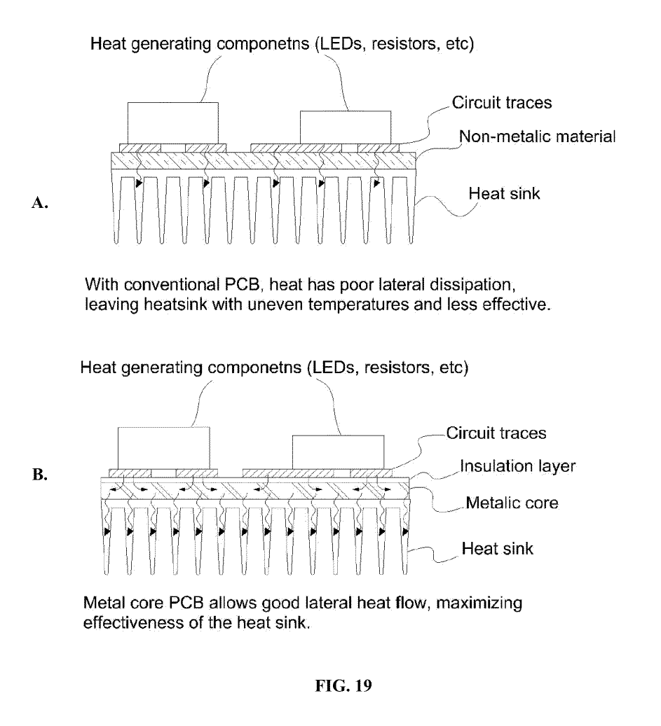

Because LEDs are high power electric components with heat sink, its printed circuit board (PCB) is usually of metal core type, for example, aluminum, which allows good lateral heat dissipation. Metal core PCB is often used for components with high heat dissipation requirement, such as high power LEDs. The advantage of metal core PCB is to allow heat to dissipate laterally along the PCB, thereby make full use of the heat sink's area. (See FIG. 19.) In contrast, a conventional non-metal pore PCB does not permit efficient heat transfer along and inside the PCB, causing the PCB to have hot spot where the components are and cool spot in between, making less use of the heat sink.

### INCORPORATION BY REFERENCE

References and citations to other documents, such as patents, patent applications, patent publications, journals, books, papers, web contents, have been made in this disclosure. All such documents are hereby incorporated herein by reference in their entirety for all purposes.

### EQUIVALENTS

The representative examples are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples and the references to the scientific and patent literature included herein. The examples contain important additional information, exemplification and guidance that can be adapted to the practice of this invention in its various embodiments and equivalents thereof.

What is claimed is:

1. An LED light bulb comprising a rotational bulb base having a rotational axis allowing secure locking of the bulb base to a matching bulb power socket through a rotational movement, the light bulb having a hemispherical emission profile with its most intense emission lateral to the rotational axis, wherein the hemispherical emission profile is directionally adjustable 360° by rotational movement along the rotational axis without unlocking the bulb base from the bulb power socket.

2. The LED light bulb of claim 1, wherein the hemispherical emission profile has its most intense emission directed perpendicular to the rotational axis.

3. The LED light bulb of claim 1, wherein the bulb power socket is a standard incandescent bulb socket.

4. The LED light bulb of claim 1, wherein the hemispherical emission profile is created by a plurality of LEDs.

5. The LED light bulb of claim 4, comprising a heat sink thermally coupled to the plurality of LEDs.

6. The LED light bulb of claim 1, having a luminous efficacy of at least 30 lumens per electric watt input.

7. (canceled)

8. (canceled)

9. The LED light bulb of claim 1, being a modular interchangeable light bulb.

10. An LED light bulb comprising:
(a) a rotational bulb base portion having a rotational axis allowing secure locking of the base portion to a matching bulb power socket through a rotational movement, wherein the base portion comprises:
an exposed positive electrical connection site and an exposed negative electrical connection site for electrical communication with the socket;
an inner cylinder having a first groove circularly placed around its outer surface and a first outward protruding lug;
a matching outer cylinder having a spatially matching second groove on its inner surface and a second matching inward protruding lug; and
a C-shaped circular spring ring having a cross-sectional profile such that, when the spring ring is placed in the first groove around the outer surface of the inner cylinder, the spring ring fits in the matching second groove around the inner surface of the outer cylinder,
wherein the first outward protruding lug intercepts the second outward protruding lug when the inner cylinder is rotated relative to the outer cylinder,
(b) a light-emitting front portion connected to the inner cylinder of the base portion, wherein the front portion comprises:
a circuit board electrically coupled to the positive electrical connection site and the negative electrical connection site;
an LED assembly comprising one or more LEDs and electrically coupled to the circuit board such that the one or more LEDs collectively provide a hemispherical emission profile directed laterally to the rotational axis of the base portion; and
a heat sink thermally coupled to the LED assembly and being capable of facilitating heat dispersion to ambient environment,
wherein the light-emitting front portion and the rotational bulb base portion collectively define a light bulb-like structure.

11. The LED light bulb of claim 10, wherein the front portion further comprises a light diffuser for diffusing light emitted from the one or more LEDs to the ambient.

12. The LED light bulb of claim 10, wherein the hemispherical emission profile has its most intense emission directed perpendicular to the rotational axis.

13. The LED light bulb of claim 10, wherein the bulb power socket is a standard incandescent bulb socket.

13. The LED light bulb of claim 10, wherein the LED assembly comprises from about 1 to about 100 LEDs.

14. (canceled)

15. The LED light bulb of claim 10, having a luminous efficacy of at least 30 lumens per electric watt input.

16. (canceled)

17. (canceled)

18. The LED light bulb of claim 10, being interchangeable with a standard incandescent light bulb.

19. The LED light bulb of claim 10, wherein the heat sink is made of aluminum.

20-23. (canceled)

24. The LED light bulb of claim 10, wherein the base portion further comprises a circular frictional band of uniform thickness attached to the outer surface of the inner cylinder.

25. An LED light bulb comprising:
(a) a rotational bulb base portion having a rotational axis allowing secure locking of the base portion to a matching bulb power socket through a rotational movement, wherein the base portion comprises:
an exposed positive electrical connection site and an exposed negative electrical connection site for electrical communication with the socket;
an inner cylinder having a groove circularly placed around its outer surface, the groove having a stop block;
an outer cylinder matching the inner cylinder, the outer cylinder comprising an opening aligned with the groove of the inner cylinder;
an intercepting pin protruding through the opening of the outer cylinder; and
an outer shell matching the outer surface of the outer cylinder;
wherein the intercepting pin intercepts the stop block of the groove when the inner cylinder is rotated relative to the outer cylinder,
(b) a light-emitting front portion connected to the inner cylinder of the base portion, wherein the front portion comprises:
a circuit board electrically coupled to the positive electrical connection site and the negative electrical connection site;
an LED assembly comprising one or more LEDs electrically coupled to the circuit board such that the one or more LEDs collectively provide a hemispherical emission profile directed laterally to the rotational axis of the base portion; and
a heat sink thermally coupled to the LED assembly and being capable of facilitating heat dispersion to ambient environment,
wherein the light-emitting front portion and the rotational bulb base portion collectively define a light bulb-like structure.

26. The LED light bulb of claim 25, wherein the front portion further comprises a light diffuser for diffusing light emitted from the one or more LEDs to the ambient.

27. The LED light bulb of claim 25, wherein the hemispherical emission profile has its most intense emission directed perpendicular to the rotational axis.

28. The LED light bulb of claim 25, wherein the bulb power socket is a standard incandescent bulb socket.

29-35. (canceled)
